(19) United States
(12) Patent Application Publication
(10) Pub. No.: US 2025/0103932 A1
(43) Pub. Date: Mar. 27, 2025

(54) METHOD AND SYSTEM FOR PERFORMING QUANTUM CALCULATIONS IN A QUANTUM NEURAL NETWORK AND FOR IMPLEMENTING QUANTUM NEURAL NETWORKS

(71) Applicant: Consiglio Nazionale delle Ricerche, Roma (IT)

(72) Inventors: Enrico PRATI, Roma (IT); Marco MARONESE, Roma (IT)

(73) Assignee: Consiglio Nazionale delle Ricerche, Roma (IT)

(21) Appl. No.: 18/725,835

(22) PCT Filed: Dec. 29, 2022
(86) PCT No.: PCT/IB2022/062866

§ 371 Date: Jul. 1, 2024

(30) Foreign Application Priority Data
Dec. 30, 2021 (IT) 102021000033071

(51) Int. Cl. G06N 10/20

(52) U.S. Cl. CPC G06N 10/20

(57) ABSTRACT

A computer implemented method for performing quantum calculations in a quantum neural network is described.

The neural network considered in this method comprises at least one input layer comprising a first number Nᵢₙ of input layer neurons adapted to receive respective input values xᵢ belonging to an input vector x. Each input layer neuron is configured to multiply the respective input value xᵢ by a respective weight value wᵢ belonging to a weight vector w. The aforesaid neural network further comprises at least one calculation neuron, operatively connected to the aforesaid input layer, and configured to provide a computation result y=f(z) calculated by applying an activation function ƒ to an argument z. Such an argument z is a scalar number calculated by the calculation neuron as the sum of the products of the input values xᵢ by the respective weights wᵢ plus a bias value b.

The method comprises the following steps:
encoding, by a first quantum process, the input values xᵢ of the input vector x into probability amplitudes of a n-qubits initial first quantum state, stored in an input register q, through a n-to-2ⁿ input encoding model, wherein the number of qubits n of the initial first quantum state is such that 2ⁿ is greater or equal to a second number equal to Nᵢₙ+3, where Nᵢₙ corresponds to the input vector dimension;
applying a quantum operator, depending on the weight values wᵢ of the weight vector w and the bias b, to said input register q to calculate said argument z as the addition of the bias b and the inner product of the input vector x and the weight vector w;
by the application of said quantum operator, producing as result a second quantum state, of the input register q, which has the value 1 and the value of the argument (z) encoded;
processing, by a second quantum process, said second quantum state of the input register (q), to calculate a value of each of a number of powers (d−1) of said argument (z), from the second order power (z²) up to the d-th order power (z^{d}), using an additional quantum buffer register (a);
by the application of said second quantum process, producing as result a third (n+d)-qubits quantum state, of the input register (q) and the additional quantum buffer register (a), which has said values (1, z, z², . . . ,z^{d}) encoded;
processing, by a third quantum process, said third quantum state to calculate said computation result y as a polynomial series expansion of the activation function ƒ, through quantum states rotations, with the rotation angles depending on coefficients of said activation function polynomial series expansion;
encoding said calculated computation result y into a fourth quantum state, which is suitable either to be measured and detected or to be provided, as a not yet measured quantum state, to a further neuron of the neural network.

A computer implemented method for implementing a quantum neural network is also described.

A quantum computation system for performing quantum calculations in a quantum neural network and a quantum computation system for implementing a quantum neural network are also described.

### TECHNOLOGICAL BACKGROUND

### Field of Application

The present invention relates to a method and system for performing quantum calculations in a quantum neural network.

The present invention also refers to a method and system for implementing quantum neural networks.

The general technical field of the present invention is quantum computing and, in particular, quantum computing adapted to execute machine-learning algorithms such as multi-layer neural networks.

### DESCRIPTION OF THE PRIOR ART

A quantum neural network encodes a neural network by the qubits of a quantum processor.

In the conventional (non-quantum) approach, biologically inspired artificial neurons are implemented by software as mathematical rate neurons.

For instance, the Rosenblatt perceptron, illustrated for example in Rosenblatt, F. “The perceptron, a perceiving and recognizing automaton Project Para” (Cornell Aeronautical Laboratory, 1957) is the simplest artificial neural network consisting of an input layer of N neurons and one output neuron behaving as a step activation function.

Multilayer perceptrons, are universal function approximators (see e.g., Suter, B. W. “The multilayer perceptron as an approximation to a bayes optimal discriminant function” IEEE Transactions on Neural Networks 1, 291 (1990)) provided they are based on squashing functions, that is monotonic functions which compress real values in a normalized interval, acting as activation functions (reference is made to Hornik, K. “Approximation capabilities of multilayer feed-forward networks” Neural networks 4, 251-257 (1991) [1]).

In principle, a quantum computer is suitable for performing tensor calculations typical of neural network algorithms.

Indeed, the qubits can be arranged in circuits acting as layers of the quantum analogue of a neural network. If equipped with common activation functions such as the sigmoid and the hyperbolic tangent, they should be able to process deep learning algorithms such those used for problems of classification, clustering and decision making.

A drawback of these solution derives from the fact that, as qubits are destroyed at the measurement event, in the sense that they are turned into classical bits, implementing an activation function in a quantum neural network poses challenges requiring a subtle approach.

Indeed, the natural aim is to preserve as much as possible the information encoded in the qubits while taking advantage of each computation at the same time. In the field of quantum machine learning, QML, if one neglects the implementation of quantum neural networks on adiabatic quantum computers, there are essentially two kinds of proposals of quantum neural networks on a gate-model quantum computer.

The first proposal consists of defining a quantum neural network as a variational quantum circuit composed of parameterized gates where non-linearity is introduced by measurements operations, as illustrated, for example, in: Farhi, E. & Neven, H. “Classification with quantum neural networks on near term processors” arXiv preprint arXiv:1802.06002 (2018); Beer, K. et al. “Training deep quantum neural networks” Nature Communications 11, 1-6 (2020); Benedetti, M., Lloyd, E., Sack, S., Fiorentini, M. “Parameterized quantum circuits as machine learning models” Quantum Science and Technology 4, 043001 (2019).

Such quantum neural networks are empirically-evaluated heuristic models of QML not grounded on mathematical theorems (Broughton, M. et al. “Tensorflow quantum: A software framework for quantum machine learning” arXiv preprint arXiv:2003.02989 (2020)). Furthermore, this type of models based on variational quantum algorithms suffer from an exponentially vanishing gradient problem, the so-called barren plateau problem.

Due to the above mentioned drawbacks, it is possible to consider a second approach, which seeks to implement a truly quantum algorithm for neural network computations and to really fulfil the approximation requirements of Hornik's theorem (refer to the already mentioned paper [1] by Hornik), perhaps at the cost of a larger circuit depth. Such approach pertains to semi-classical model (see e.g., Daskin, A. “A simple quantum neural net with a periodic activation function” in 2018 IEEE International Conference on Systems, Man, and Cybernetics (SMC), 2887-2891) or fully quantum (see e.g., Cao, Y., Guerreschi, G. G. & Aspuru-Guzik, A. “Quantum neuron: an elementary building block for machine learning on quantum computers” arXivpreprintarXiv:1711.11240(2017)), whose non-linear activation function is again computed via measurement operations.

Furthermore, quantum neural network proposals can be classified with respect to the encoding method of input data.

Since a qubit consists of a superposition of the state 0 and 1, few encoding options are distinguishable by the relations between the number of qubits and the maximum encoding capability.

The first option is the 1-to-1 option by which each and every input neuron of the network corresponds to one qubit (see e.g., the already mentioned Cao, Y., Guerreschi, G. G. & Aspuru-Guzik, A. “Quantum neuron: an elementary building block for machine learning on quantum computers”; or da Silva, A. J., de Oliveira, W. R. & Ludermir, T. B. “Weightless neural network parameters and architecture selection in a quantum computer” Neurocomputing 183, 13-22 (2016). The most straightforward implementation of this option consists in storing the information as a string of bits assigned to classical base states of the quantum state space.

A similar 1-to-1 method consists in storing a superposition of binary data as a series of bit strings in a multi-qubit state. Such quantum neural networks are based on the concept of the quantum associative memory (see e.g., Ventura, D. & Martinez, T. “Quantum associative memory” Information Sciences 124, 273-296 (2000)).

Another 1-to-1 option is given by the quron (quantum neuron). A quron is a qubit whose 0 and 1 states stand for the resting and active neural firing state, respectively (see e.g., Schuld, M., Sinayskiy, I. & Petruccione, F. “The quest for a quantum neural network” Quantum Information Processing 13, 2567-2586 (2014)).

Alternatively, another encoding option consists in storing the information as coefficients of a superposition of quantum states, as illustrated, for example, in Shao, C. “A quantum model for multilayer perceptron” arXiv preprint arXiv:1808.10561 (2018); or Tacchino, F., Macchiavello, C., Gerace, D. & Bajoni, D. “An artificial neuron implemented on an actual quantum processor” npj Quantum Information 5, 26 (2019).

The encoding efficiency becomes exponential as an n-qubit state is an element of a 2n-dimensional vector space. To exemplify, the treatment by a quantum neural network of a real image classification problem of few megabits makes the 1-to-1 option currently not viable (see e.g., Pritt, M. & Chern, G. “Satellite image classification with deep learning” in 2017 IEEE Applied Imagery Pattern Recognition Workshop (AIPR), 1-7).

Instead, the choice n-to-2n allows to encode a megabit image in a state by using 20 qubits only.

However, encoding the inputs as coefficients of a superposition of quantum states requires an algorithm for generic quantum state preparations (see e.g., Shende, V. V., Bullock, S. S. & Markov, I. L. “Synthesis of quantum-logic circuits” IEEE Transactions on Computer-Aided Design of Integrated Circuits and Systems 25, 1000-1010 (2006), or, alternatively, requires to directly feed quantum data to the network (see e.g., Romero, J., Olson, J. P. & Aspuru-Guzik, A. “Quantum autoencoders for efficient compression of quantum data” Quantum Science and Technology 2, 045001 (2017)).

For instance, quantum encoding methods such as Flexible Representation of Quantum Images (FRQI) have been proposed.

Generally, to prepare an arbitrary n-qubit quantum state requires a number of quantum gates that scales exponentially in n. Nonetheless, in the long run, a n-to-2n encoding guarantees a better applicability to real problems than the options 1-to-1. Moreover, such encoding method satisfies the requirements of Hornik's theorem in order to guarantee the universal function approximation capability. However, even considering this option, some relatively heavy constraints remain such as the digital encoding and the fact that the activation function involves irreversible measurements.

Therefore, there is an urgent need to devise and provide solutions for implementing quantum neural networks or quantum perceptrons that are improved in such a way to solve the above mentioned drawbacks and challenges.

As far as the Applicants know, the above mentioned technical problem, and the related needs that are particularly felt in the considered technical field, are not solved, up to now, in a satisfactory manner.

### SUMMARY OF THE INVENTION

It is an object of the present invention to provide a method for performing quantum calculations in a quantum neural network, which allows to solve, at least partially, the drawbacks described above with reference to the prior art and respond to the aforesaid needs particularly felt in the technical field under consideration. Such an object is achieved by a method according to claim 1.

Further embodiments of such a method are defined in claims 2-9.

It is also an object of the present invention to provide a method for implementing quantum neural networks, based on the aforesaid method for performing quantum calculations in a quantum neural network. Such an object is achieved by a method according to claim 10.

Further embodiments of such a method are defined in claims 11-13.

It is also an object of the present invention to provide a quantum computation system capable to carry out the abovementioned method for performing quantum calculations in a quantum neural network. This object is achieved by a system according to claim 14.

It is also an object of the present invention to provide a quantum computation system capable to carry out the abovementioned method for implementing a quantum neural network. This object is achieved by a system according to claim 15.

### BRIEF DESCRIPTION OF THE DRAWINGS

Further features and advantages of the method and system according to the invention will become apparent from the following description of preferred embodiments, given by way of indicative, non-limiting examples, with reference to the accompanying drawings, in which:

FIGS. 1A and 1 B provide a graphical representation of a one-layer perceptron and a relative qubit-based version, respectively;

FIGS. 2A and 2B illustrates two examples of quantum circuits of a qubit-based one-layer perceptron, according to respective embodiments of the present invention;

FIG. 3, diagrams a-d, are diagrams representing results obtained by applying embodiments of the method of the invention, and in particular enlarged views of the output of a quantum one-layer perceptron with different analytical activation functions;

FIG. 4 shows an example of fundamental gates composition of the transformations U_{W;b} and Uₓ that are used in an embodiment of the method of the invention;

FIG. 5 shows a scheme of a neural network which can be implemented by a method comprised in the invention.

### DETAILED DESCRIPTION

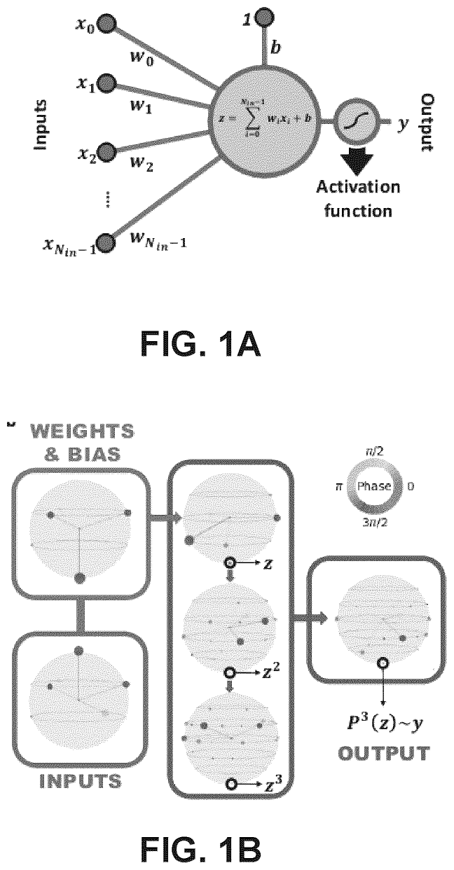

A computer implemented method for performing quantum calculations in a quantum neural network (or related to a quantum neural network) is described, making reference to the FIGS. 1-5.

The neural network considered in this method comprises at least one input layer comprising a first number Nᵢₙ of input layer neurons adapted to receive respective input values xᵢ belonging to an input vector x.

Each input layer neuron is configured to multiply the respective input value xᵢ by a respective weight value wᵢ belonging to a weight vector w.

The aforesaid neural network further comprises at least one calculation neuron, operatively connected to the aforesaid input layer, and configured to provide a computation result y=f(z) calculated by applying an activation function ƒ to an argument z. Such an argument z is a scalar number calculated by the calculation neuron as the sum of the products of the input values xᵢ by the respective weights wᵢ plus a bias value b.

The method comprises the following steps:
encoding, by a first quantum process (e.g., by means of a first quantum circuit), the input values xᵢ of the input vector x into probability amplitudes of a n-qubits initial first quantum state, stored in an input register q, through a n-to-2ⁿ input encoding model, wherein the number of qubits n of the initial first quantum state is such that 2¹ is greater or equal to a second number equal to Nᵢₙ+3, where Nᵢₙ corresponds to the input vector dimension;
applying a quantum operator (e.g., by means of quantum processing means), depending on the weight values wᵢ of the weight vector w and the bias b, to said input register q to calculate said argument z as the addition of the bias b and the inner product of the input vector x and the weight vector w;
by the application of said quantum operator, producing as result (e.g., by means of a second quantum circuit) a second quantum state, of the input register q, which has the value 1 and the value of the argument z encoded;
processing, by a second quantum process, said second quantum state of the input register q, to calculate a value of each of a number of powers (d-1) of said argument z, from the second order power z² up to the d-th order power z^{d}, using an additional quantum buffer register a;
by the application of said second quantum process, producing as result a third (n+d)-qubits quantum state, of the input register q and the additional quantum buffer register a, which has said values (1, z, z², . . . ,z^{d}) encoded;
processing, by a third quantum process (e.g., by means of a third quantum circuit), said third quantum state to calculate said computation result y as a polynomial series expansion of the activation function ƒ, through quantum states rotations, with the rotation angles depending on coefficients of said activation function polynomial series expansion;
encoding said calculated computation result y into a fourth quantum state, which is suitable either to be measured and detected or to be provided, as a not yet measured quantum state, to a further neuron of the neural network.

According to an embodiment, computing the elements of the said powers/series (z², . . . , z^{d}) encodes them, together with the encoding of 1 and z, into the third (n+d)-qubits quantum state. In this case, the above mentioned functional steps of “calculating” and “encoding” a quantum state are actually performed simultaneously, as one processing step, as it is typical in quantum processing. Nonetheless, the present description mentions the two functional steps for the purpose of clarity.

According to an embodiment, said steps of encoding implies the storing of the encoded calculation results.

According to a method embodiment, the aforesaid step of applying a quantum operator to the input register q provides the following quantum operations:
2ⁿ-1 quantum states rotations, with the rotation angles depending on the weight values wᵢ of the weight vector w and the bias b such that 2ⁿ is greater or equal to said second number (Nᵢₙ+3);
processing said n-qubits initial first quantum state and the quantum operator depending on the weight and bias to calculate said argument z as the addition of the bias b and the inner product of the input vector x and the weight vector w.

According to an embodiment, said number of powers d is equal to or lower than 10 so that the activation function is approximated by a Taylor series expansion having 10 addends or less.

According to a preferred implementation option, said number of powers d is 3 so that the activation function is approximated by a Taylor series expansion having 3 addends.

According to an embodiment, said weights wᵢ and bias b are comprised in the closed range of real numbers comprised between −1 and 1.

According to a method embodiment, the aforesaid step of processing, by a second quantum process, the second quantum state to calculate a value of each of a number of powers d−1 of the argument z comprises applying by the second quantum process a unitary transformation U_{z}(x, w, b) which satisfies the following equation:

$$〈 N - 1 \vert {U}_{z} ( \vec{x} , \vec{w} , b ) \vert 0 〉 = \frac{\vec{w} \cdot \vec{x} + b}{{N}_{in} + 1} ≡ z$$

$${{where \vert 0 〉 ≡ \vert 0 〉}^{⊗ n} and \vert N - 1 〉 ≡ \vert 1 〉}^{⊗ n} .$$

A theoretical basis for the calculations above is provided by the following Lemma 1 and Theorem 1.

Lemma 1 Given two vectors \vec{x}, \vec{w} ∈[−1, 1]^{N}^{_{IN}} and a number b∈[−1, 1]. and given a register of n qubits such that N=2ⁿ≥Nᵢₙ+3, then there exists a quantum circuit realizing a unitary transformation U_{z}(\vec{x}, \vec{w}, b) such that

$$〈 N - 1 \vert {U}_{z} ( \vec{x} , \vec{w} , b ) \vert 0 〉 = \frac{\vec{w} \cdot \vec{x} + b}{{N}_{in} + 1} ≡ z \qquad ( 1 )$$

where |0 [symbol] ≡|0 [symbol] ^{On} and |N−1 [symbol] ≡|1 [symbol] ^{On}

Theorem 1 Let z be the real value in the interval [−1, 1] assumed by (\vec{w}·\vec{x}+b)/(Nᵢₙ÷1) where \vec{x}, \vec{w}∈[−1,1] and b∈[−1,1]. Let q and a be two registers of n and d qubits respectively, with N=2ⁿ≥Nᵢₙ+3. Then there exists a quantum circuit which transforms the two registers from the initial state |0 [symbol] ₐ|0 [symbol] _{q} to a (n+d)-qubit entangled state |ψ_{z}^{d} [symbol] of the form

$${{{\vert {ψ}_{z}^{d} 〉 = \vert {ψ}_{z}^{d} 〉}_{⊥} + \frac{1}{{2}^{d / 2}} \vert z 〉}_{a}^{⊗ d} \vert N - 1 〉}_{q} , \qquad ( 2 )$$

$$where$$

$${{\vert N - 1 〉 〈 N - 1 \vert}_{q} \vert {ψ}_{z}^{d} 〉}_{⊥} = 0$$

$$and$$

$$\vert z 〉 ≡ \vert 0 〉 + z \vert 1 〉 .$$

According to a method embodiment, the aforesaid step of producing a third (n+d)-qubits quantum state comprises:
transforming the input register q and the additional quantum buffer register a from an initial state |0>ₐ|0>_{q} to a (n+d)-qubit entangled state |ψ_{z}^{d}> according to the relationship:

$${{{\vert {ψ}_{z}^{d} 〉 = \vert {ψ}_{z}^{d} 〉}_{⊥} + \frac{1}{{2}^{d / 2}} \vert z 〉}_{a}^{⊗ d} \vert N - 1 〉}_{q}$$

$$where :$$

$${{\vert N - 1 〉 〈 N - 1 \vert}_{q} \vert {ψ}_{z}^{d} 〉}_{⊥} = 0$$

$$\vert z 〉 ≡ \vert 0 〉 + z \vert 1 〉 .$$

wherein the state |ψ_{z}^{d}> stores as probability amplitudes all the powers z^{k}, for k=0, 1, . . . , d.

According to an embodiment, the aforesaid step of processing, by a third quantum process, the third quantum state to calculate the computation result y comprises:
transforming the state |ψ_{z}^{d} [symbol] so as to achieve a special recursively defined d-degree polynomial in z, by means of a unitary operator U_{d} of the family (Uₖ; k=1, . . . , d) of unitary operators such that

$${}_{a} {〈 0 \vert {U}_{k} \vert z 〉}_{a}^{⊗ d} = {f}_{k} ( z )$$

where fₖ(z) is the polynomial series expansion of the activation function up to the k-th power, and f_{d}(z) is the polynomial series expansion of the activation function up to the d-th power, and wherein Uₖ is obtained through a recursive law Uₖ=Cₖ Uₖ₋₁, wherein Cₖare coefficients depending on the specific activation function (ƒ) considered.

The theoretical basis for the above mentioned procedure is provided by the following Theorem 2 and Corollary 2.1.

Theorem 2 Let {fₖ, k=1, . . . ,d} be the family of polynomials in z defined by the following recursive law

$${f}_{k} ( z ) = {f}_{k - 1} ( z ) cos {ϑ}_{k - 1} - {z}^{k} sin {ϑ}_{k - 1} , k - 1 , … , d , \qquad ( 6 )$$

$$with {f}_{0} ( z ) = 1 and {ϑ}_{k} ∈ [ - \frac{π}{2} , \frac{π}{2} ] for any k = 0 , … , d - 1.$$

Then there exists a family {Uₖ, k=1, . . . , d} of unitary operators such that

$${}_{a} {〈 0 \vert {U}_{k} \vert z 〉}_{a}^{⊗ d} = {f}_{k} ( z ) . \qquad ( 7 )$$

These unitary operators are, in turn, defined by the recursive law

$${U}_{k} = \text{?} {R}_{y} ( - 2 {θ}_{k - 1} \text{?} {U}_{k - 1} , k = 1 , … , d , \qquad ( 8 )$$

$$with {U}_{0} = .$$

$$\text{?} \text{indicates text missing or illegible when filed}$$

Corollary 2.1 Let f be a real analytic function over a compact interval I. If f_{d} is the top member of the family of polynomials defined in Theorem 2 (Eq. 6) then the angles θₖ, k=0, . . . , d−1 can be chosen in such a way that f_{d}(z) coincides with the d-order Taylor expansion of f(z) around z=0, up to a constant factor C_{d} which depends on f and on the order d as

$${C}_{d} = {a}_{k} {\prod }_{j = k}^{d - 1} {( cos {ϑ}_{j} )}^{- 1} , \qquad ( 9 )$$

where

$${a}_{k} = \frac{1}{k !} {f}^{( k )} ( 0 )$$

is the first non-zero coefficient of the expansion and f^{(k)} the k-order derivative of f.

According to an embodiment, the aforesaid step of processing further comprises defining the rotation angles, based on said polynomial series expansion of the activation function up to the d-th power, to obtain an approximated activation function ƒ_{d}(z), approximating the activation function ƒ(z), wherein the approximated activation function ƒ_{d}(z) is associated to the final quantum state |ψ_{f(z)}^{d} [symbol] .

A computer implemented method for implementing a quantum neural network, based on the computer implemented method for performing quantum calculations in a quantum neural network described above, is illustrated herein below.

The quantum neural network implemented by the method comprises at least one input layer and one output layer. The at least one input layer comprises a first number Nᵢₙ of input layer neurons adapted to receive respective input values xᵢ belonging to an input vector x.

Each input layer neuron is configured to multiply the respective input value xᵢ by a respective weight value wᵢ belonging to a weight vector w.

The at least one output layer comprises an output layer neuron configured to provide a computation result y=f(z) calculated by applying an activation function ƒ to an argument z. The argument z is a scalar number calculated by the output layer neuron as the sum of the products of the input values xᵢ and respective weights wᵢ plus a bias value b.

The method for implementing a quantum neural comprises executing the method for performing quantum calculations in a quantum neural network, according to any of the embodiment described above, in which said calculation neuron plays the role of output layer neuron.

The method then provides measuring the calculated computation result y, encoded in the aforesaid fourth quantum state, to detect and made available the result of the neural network computation.

According to an embodiment of this method, the neural network output layer comprises one or more output layer neurons, and the aforesaid neural network is a multi-layer neural network further comprising at least one intermediate layer, in which the intermediate layer comprises a plurality of intermediate-layer neurons, and wherein each of the intermediate-layer neurons is connected to all the input layer neurons, in input, and to said one or more output layer neurons, in output.

In this case, the method further comprises the following steps:
for each of the intermediate-layer neurons, executing the method for performing quantum calculations in a quantum neural network, according to any of the embodiment described above, in which said calculation neuron plays the role of intermediate-layer neuron, and the intermediate-layer neuron provides, as a computation result y, a computation value xᵢ;
providing all the calculated computation values xᵢ, as a not yet measured quantum state, to the one or more output layer neurons, so that, from the point of view of the output layer neurons, the intermediate layer plays the role of the input layer of said method for performing quantum calculations in a quantum neural network;
measuring the calculated computation result y, by the one or more output layer neurons, to detect and made available the result of the neural network computation.

According to another method embodiment, the aforesaid neural network is a multi-layer neural network further comprising a plurality of intermediate layers, wherein each neuron of an intermediate layer is connected, in input, to all the neurons of the preceding intermediate layer, and the one or more output layer neurons are connected to the outputs of the neurons of the last intermediate layer.

In this case, the aforesaid step of executing, for each of the intermediate-layer neurons, the method for performing quantum calculations in a quantum neural network the intermediate layer is repeated for each intermediate layer.

According to an implementation option of the method, the only quantum measurement provided by the method is carried out to detect the amplitudes of the quantum states after the processing by said output layer neurons, to obtain said computation result y.

A quantum computation system for performing quantum calculations in a quantum neural network is hereafter described.

The neural network on which this system can perform calculations in this method comprises at least one input layer comprising a first number Nᵢₙ of input layer neurons adapted to receive respective input values xᵢ belonging to an input vector x.

Each input layer neuron is configured to multiply the respective input value xᵢ by a respective weight value wᵢ belonging to a weight vector w.

The aforesaid neural network further comprises at least one calculation neuron, operatively connected to said input layer, and configured to provide a computation result y =f(z) calculated by applying an activation function ƒ to an argument z.

The argument z is a scalar number calculated by the calculation neuron as the sum of the products of the input values xᵢ by the respective weights wᵢ plus a bias value b.

The system comprises a first quantum circuit, an input register x, quantum processing means, a quantum buffer register a, a second quantum circuit, a third quantum register, a third quantum circuit, a fourth quantum register.

The first quantum circuit is configured to encode the input values xᵢ of the input vector x into probability amplitudes of a n-qubits initial first quantum state, through a n-to-2ⁿ input encoding model, wherein the number of qubits n of the initial first quantum state is such that 2ⁿ is greater or equal to a second number equal Nᵢₙ+3 where Nᵢₙ corresponds to the input vector dimension.

The input register x is configured to store said probability amplitudes of a n-qubits initial first quantum state.

The quantum processing means are configured to apply a quantum operator, depending on the weight values wᵢ of the weight vector w and the bias b, to the input register q to calculate the aforesaid argument z as the addition of the bias b and the inner product of the input vector x and the weight vector w. The application of the aforesaid quantum operator produces as result a second quantum state, of the input register q, which has the value 1 and the value of the argument (z) encoded.

The quantum buffer register a is distinct from said input register.

The second quantum circuit is configured to be applied to the input register x and the quantum buffer register a, to process said second quantum state to calculate a value of each of a number of powers d of the aforesaid argument z, from the second order power z² up to the d-th order power z^{d}, producing as result a third (n+d)-qubits quantum state, of the input register (q) and the additional quantum buffer register (a), which has said values (1, z, z², . . . ,z^{d}) encoded.

The third quantum register is configured to store the above mentioned third (n+d)-qubits quantum state.

The third quantum circuit is operatively connected to said third quantum register, and is configured to process the aforesaid third quantum state to calculate the computation result y as a polynomial series expansion of the activation function ƒ, through quantum states rotations, with the rotation angles depending on coefficients of the activation function polynomial series expansion.

The fourth quantum register is configured to store a fourth quantum state which encodes the aforesaid calculated computation result y.

A quantum computation system for implementing a quantum neural network is hereafter described.

Such a system comprises a quantum computation system for performing quantum calculations in a quantum neural network, as described above, and moreover quantum measurement means, configured to measure the calculated computation result y, encoded in said fourth quantum state, to detect and made available the result of the neural network computation.

Further embodiments of the method of the invention are described here below in more detail, as non-limiting examples.

In order to define the quantum version of the perceptron with continuous parameters and arbitrary analytic activation function, here disclosed, let's consider a one-layer perceptron, the fundamental unit of a feed-forward neural network.

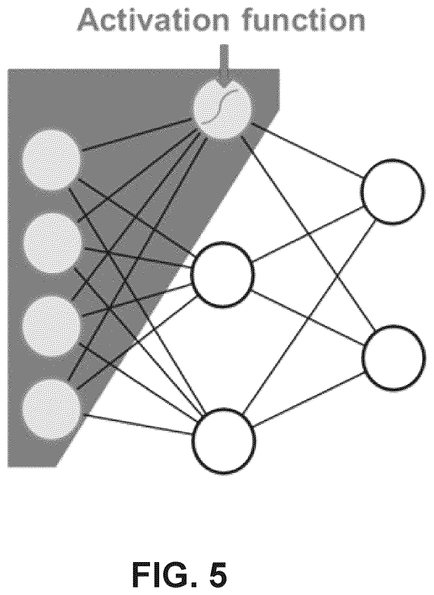

A one-layer perceptron (represented by the shaded part of FIG. 5) is composed of Nᵢₙ input neurons and one output neuron equipped of an activation function ƒ: R →I where I is a compact set.

The output neuron computes the inner product between the vector of the input values x=(x0; x1; . . . ; x_{Nin-1}) E R^{Nin} and the vector of the weights w=(w0; w1; . . . ; w_{Nin-1})∈R^{Nin} plus a bias value b∈R. Such scalar value is taken as the argument of an activation function. The real output value y∈I of the perceptron is defined as y=f (w·x+b) as indicated in FIG. 1A.

Here, a quantum circuit that computes an approximation of y is developed.

The algorithm starts by calculating the inner product w·x plus the bias value b.

Next, it evaluates the output y by calculating an approximation of the activation function ƒ.

On a quantum computer, a measurement operation apparently represents the most straightforward implementation of a non-linear activation function.

As already noted, this approach, however, cannot be generalized to build a multi-layered qubit-based feed-forward neural network. In fact, first, measurement operations break the quantum algorithm and impose initialization of the qubits layer by layer, thus preventing a single quantum run of a multi-layer neural network. Secondly, other activation functions, beside that implied by the measurement operations, are more suitable to solve generic problems of machine learning.

In order to avoid both of these shortcomings, an embodiment of the method adopts a new quantum algorithm, which is based on two theorems as detailed below.

The quantum algorithm is composed of two steps (as represented in FIG. 11B):
first, the powers of w·x+b are stored as amplitudes of a multi-qubit quantum state;
next, the chosen activation function is approximated by building its polynomial series expansion through rotations of the quantum state.

The rotation angles are determined by the coefficients of the polynomial series of the chosen activation function and can be explicitly computed by our quantum algorithm.

FIG. 1 B represents the quantum version of the non-quantum neural network depicted in FIG. 1A. The quantum neural network of FIG. 1B follows the same architecture of the neural network of FIG. 1A, but the calculus consists of a sequence of transformations of a n-qubits quantum state initialized with the coefficients of the inputs vector x as probability amplitudes.

The quantum states at each step are represented by a q-sphere (graphical representation of a multi-qubit quantum state). In a q-sphere each point is a different coefficient of the superposition quantum state.

Generally, the coefficients are complex, and in a q-sphere the modules of the complex coefficients are proportional to the radius of the points, while the phases depend on the colour.

In the box “input” the starting quantum state is shown, with the inputs stored as probability amplitudes. In the box “weights & bias” the quantum state with the weights and the bias is shown. In the central rectangular box, at each step, one qubit is added in order to store the power terms of z up to d (d=3 in FIG. 1B). In the box “output” the output of the perceptron is given by a series of rotations which compose a polynomial P^{d}(z) (d=3 in FIG. 1B).

Further details on the steps of the method are provided here below. In the following, two qubit registers “q” and “a” of n and d qubits, respectively, are assumed to be assigned.

A. Computation of the power terms

The aim of this step is to build a (n+d)-qubits quantum state containing the Taylor expansion of f(z) to order d, where z=w·x+b up to a normalization factor. The number n of required qubits, in addition to d, is determined by the dimension of the input vector.

First, it is necessary to encode the powers (1; z; z²; . . . ; z^{d}) in the (n+d) qubits.

The starting point is the above mentioned Lemma 1, and in particular the equation:

$$〈 N - 1 \vert {U}_{z} ( \vec{x} , \vec{w} , b ) \vert 0 〉 = \frac{\vec{w} \cdot \vec{x} + b}{{N}_{in} + 1} ≡ z$$

The transformation U_{z}(x, w, b) is a key building block of the quantum perceptron algorithm.

Indeed, in the quantum circuit here considered, such transformation is iterated several times over the Hilbert space enlarged to [symbol] ᵤ^{⊗d} ⊗ [symbol] ᵤ^{⊗n} by the addition of another register a of d qubits.

The existence of such a quantum circuit is guaranteed by the already mentioned Theorem 1, that provides its explicit construction.

Theorem 1 provides the relationship:

$${{{\vert {ψ}_{z}^{d} 〉 = \vert {ψ}_{z}^{d} 〉}_{⊥} + \frac{1}{{2}^{d / 2}} \vert z 〉}_{a}^{⊗ d} \vert N - 1 〉}_{q}$$

$$where$$

$${{\vert N - 1 〉 〈 N - 1 \vert}_{q} \vert {ψ}_{z}^{d} 〉}_{⊥} = 0$$

$$\vert z 〉 ≡ \vert 0 〉 + z \vert 1 〉 .$$

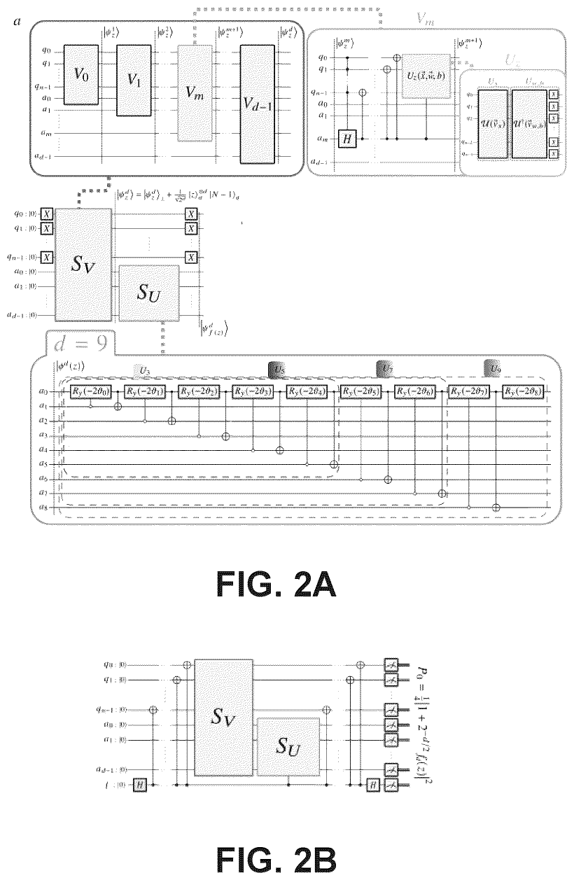

The circuit (illustrated in FIG. 2A) is expressed as

SᵥX_{q}^{⊗n}

where X is the quantum NOT gate and

$${S}_{V} = {V}_{d - 1} … {V}_{1} {V}_{0}$$

$$with$$

$${V}_{m} = \text{?} {{U}_{z} ( \text{?} , \text{?} , b )}_{q} \text{?} , m = 0 , 1 , … , d - 1.$$

$$\text{?} \text{indicates text missing or illegible when filed}$$

To summarize, the quantum circuit of the quantum perceptron algorithm starts by expressing the unitary operator which initializes the q and a registers from the state |0>ₐ|0>_{q} to the state |ψ_{z}^{d}>. Such a unitary operator is expressed by:

SᵥX_{q}^{⊗n}
where Sᵥ(illustrated in detail in FIG. 2A) is the subroutine of the quantum circuit which achieves the goal of the first step of the quantum perceptron algorithm, i.e., to encode the powers of z up to the power d in a quantum state.

In fact, the state |ψ_{z}^{d}> stores as probability amplitudes all the powers z^{k} for k=0, 1, . . . , d, up to the trivial factor, according to the following relationship (implied by Theorem 1):

$${}_{q} 〈 N - 1 \vert {}_{a} 〈 {2}^{k - 1} \vert {ψ}_{z}^{d} 〉 = {2}^{- d / 2} {z}^{k} , k = 0 , 1 , … , d .$$

B. Computation of the polynomial series

The next step of the algorithm consists in transforming the state |yz^{d}> so as to achieve a special recursively defined d-degree polynomial in z.

Such step is identifiable with the subroutine S_{U} of the quantum perceptron circuit shown in FIG. 2A.

S_{U} is a unitary operator (the existence of which can be derived from Theorem 1) which acts as the identity on [symbol] _{q} and returns, when applied to |z [symbol] ₐ^{⊗d}· a new state which stores the polynomial.

The state which stores the polynomial up do the d-th power is U_{d} (corresponding to the subroutine S_{U} in FIG. 2A) belonging to the unitary operators defined by the recursive law (see the above mentioned Theorem 2):

$${U}_{k} = {C}_{{a}_{0}} {X}_{{a}_{k}} {\overline{C}}_{{a}_{k}} {R}_{y} {( - 2 {ϑ}_{k - 1} )}_{{a}_{0}} {U}_{k - 1} , k = 1 , … , d ,$$

FIG. 2A represents a quantum circuit, according to the present invention, which returns the state |ψ^{d}_{f(z)}> which encodes the value f_{d}(z) as stated by the above mentioned

### Theorems 1 and 2.

In a more general context, f_{d}(z) is the output value of a neuron of a deep neural network hidden layer, as no measurement is required when the information is sent to the next layer.

The subroutine S_{U} is described in the upper box of FIG. 2A, where the general case of S_{U} is shown.

The subroutines S_{U} is described in the lower box of FIG. 2A, where it is shown a particular case at d=9. Such value corresponds to the maximum order of d=9 of the polynomial expansion used for approximating the activation functions tanh, sigmoid and sine.

FIG. 2B shows a complete quantum circuit of a qubit-based one-layer perceptron. In such case, by performing the measurements of all the qubits and averaging after many repetitions of the circuit, it is possible to estimate the output y_{q} of the one-layer perceptron.

C. Approximation of analytical activation functions

The transformation S_{U}=U_{d}⊗X^{⊗n} applied on |ψ^{d}_{z}> returns a state with the probability amplitude associated to |0>ₐ |0>_{q} equal to 2^{-d/}2f_{d}(z).

Let's denote such final quantum state of (n+d)-qubits as |ψ^{d}_{f(z)}>.

According to Theorem 2, f_{d}(z) is a d-degree polynomial with coefficients depending on d angles θₖ, where k=0; . . . ; d−1, according to the recursive law:

$${f}_{k} ( 𝓏 ) = {f}_{k - 1} ( 𝓏 ) cos {ϑ}_{k - 1} - {𝓏}^{k} sin {ϑ}_{k - 1} , k = 1 , … , d ,$$

Still from Theorem 2, there follows the above mentioned Corollary 2.1 which shows how to set such angles θₖ in order to approximate an arbitrary analytical activation function ƒ(z) by f_{d}(z).

According to Corollary 2.1, the angles θₖ can be chosen in such a way that f_{d}(z) coincides with the d-order Taylor expansion of f(z) around z=0, up to a constant factor C_{d}which depends on f and on the order d as

$${C}_{d} = {a}_{k} {\prod }_{j = k}^{d - 1} {( cos {ϑ}_{j} )}^{- 1}$$

$$where$$

$${a}_{k} = \frac{1}{k !} {f}^{( k )} ( 0 )$$

is the first non-zero coefficient of the expansion and f^{(k)} is the k-order derivative of the function ƒ.

D. Computation of the amplitude

To summarize, the quantum circuit so far defined employs n+d qubits and it performs two transformations: the first sends the state |0 [symbol] ₐ^{⊗d} |0 [symbol] _{q}^{⊗n} into |ψ^{d}_{z} >, as a consequence of Theorem 1, while the second is S_{U}⊗X^{⊗n} which returns a state having 2^{-d/2}f_{d}(z) as probability amplitude corresponding to the state |0>ₐ |0>_{q}.

An important property of such quantum circuit, which is shown in the FIG. 2A, is that it encodes the value f_{d}(z) (up to the constant 2^{-d/2}), which is non-linear with respects to the input values x, in a quantum state (the state |ψ^{d}_{f(z)}>).

Indeed, in a generic context, the quantum circuit in FIG. 2A can be integrated in a circuit for a multi-layer qubit-based neural network. In such context the value f^{d}(z) corresponds to the output value of a hidden neuron.

The freedom left by the non-destroying activation function makes possible to build a deep qubit-based neural network. Each new layer receives quantum states, like the state prepared to enter the network at the first layer.

As last result, it is explicitly illustrated, here below, how to operate the last layer of the network, by focusing, for example, on the case of a one-layer perceptron.

While the circuit in FIG. 2A returns a state |ψ^{d}_{f(z)}> which has the value 2^{-d/2}f_{d}(z) encoded as a probability amplitude, the circuit in FIG. 2B allows to estimate such amplitude. It implements a qubit-based version of a one-layer perceptron. Any quantum algorithm ends by extracting information from the quantum state of the qubits by measurement operations.

Applying the measurement operations to the qubits of the circuit of FIG. 2A allows to estimate only the probability to measure a given quantum state, but from the probability it is not possible to compute the inherent amplitude. Indeed, the probability is the square module of the amplitude, therefore, it does not preserve the information about the phase factor (the sign for real values) of the amplitude.

To achieve such a goal a straightforward method consists in defining a quantum circuit which returns a quantum state with a value ½ (1+2^{-d/2} f_{d}(z)) stored as a probability amplitude, a task operated by the circuit in the FIG. 2B.

Such quantum circuit operates on a register I of a single qubit, in addition to the registers q and a, and it returns the probability ¼ [1+2^{-d/2} f_{d}(z)|² to observe the state |0>ₗ|0>ₐ|0>_{q}.

The above mentioned Theorems 1 and 2 imply that a quantum state with 2^{-d/2}f_{d}(z) as superposition coefficient does exist and, since any quantum state |ψ> is normalized then 2^{-d/2} f_{d}(z)≤1. From such results, by defining P₀=¼[1+2^{-d/2}f_{d}(z)|² it is possible to reverse the equation to find f_{d}(z), once given the probability P₀.

Therefore, the quantum perceptron algorithm consists of an estimation of the probability P₀ feasible with a number s of measurement operations of all the qubits. The error over the estimation of P₀ depends on the number of samples s. The resulting output of the qubit-based perceptron is written as

$${y}_{q} = {2}^{d / 2} ( 2 \sqrt{P} - 1 ) {C}_{d}$$

where P is the estimation of P₀ and C_{d} is given by the above mentioned equation:

$${C}_{d} = {a}_{k} {\prod }_{j = k}^{d - 1} {( cos {ϑ}_{j} )}^{- 1}$$

Hence y_{q} provide the estimation of the value f_{d}(z), which is the polynomial expansion of the activation function ƒ at the order d.

Once the estimation of P₀ is obtained by a quantum computation, the value y_{q} is derived by a classical computation. The estimation of P₀ is given by P=m/S where S is the total number of the measurements of |0 [symbol] 0|_{f} ⊗[0 [symbol] 0|ₐ⊗|0 [symbol] 0|_{q} and m is the number of those measurements which return 1 as result.

A second possible way to estimate y_{q} is given by the following quantum amplitude estimation algorithm. Let's consider a transformation A such that

$$𝒜 \vert 0 〉 = \vert Ψ 〉 = \sqrt{1 - a} \vert {ψ}_{0} 〉 + \sqrt{a} \vert {ψ}_{1} 〉$$

where |ψ₀> and |ψ₁> are n-qubits states and a ∈[0, 1], the quantum amplitude estimation algorithm computes, with an additional register of m qubits, a value A such that at most |ã-a |˜O(M⁻¹) where M=2^{m}.

Therefore, to apply to the case under consideration, namely

$${X}^{⊗ n} {S}_{U} {S}_{V} {X}^{⊗ n} \vert 0 {〉}^{⊗ d} \vert 0 {〉}^{⊗ n} = \vert {ψ}_{f ( 𝓏 )}^{d} 〉$$

one may take [symbol] =X^{⊗n} S_{U}S_{y}X^{⊗n}; a state over n+d qubits |ψ [symbol] =|ψ_{f(z)}^{d} [symbol] and \sqrt{a}=2^{-d/2}f_{d}(z), respectively, so that the output of the perceptron can be expressed as

$${y}_{q} = {2}^{d / 2} \sqrt{\overline{a}} {C}_{d} - γ$$

where y is the shift value used to make the function ƒ_{d}(z)∈[0,1] within z∈[−1, 1].

In the following, information about the test and validation of the method is provided.

The results derived above allow to implement a multi-layered perceptron of arbitrary size in terms of neurons per layer as well as number of layers. To test it, one may restrict the quantum algorithm to a one-layer perceptron. The tensorial calculus to obtain both z and f_{d}(z) has to be performed by a quantum computer and eventually ends with a probability estimation.

The estimation P of the probability, accordingly over y_{q}, is subject to two distinct kinds of errors: one depending on the quantum hardware and a random error due to the statistics of m which is hardware-independent.

In the following discussions, the error is analyzed as a function of the required qubits (n and d) and the number of samples S. The case of a qubit-based one-layer perceptron with Nᵢₙ=4 is then explored in order to verify the capability of the algorithm to approximate f(z). Because of the significant number of quantum gates involved, a quantum simulator has been used.

Error estimation and analysis.

It has been shown that y_{q} depends on P the estimation of the probability that a measurement of |0 [symbol] 0|ₗ ⊗|0 [symbol] 0|ₐ⊗|0 [symbol] 0|_{q} returns 1 as a result.

The estimation P is subject to a random error. Indeed P=m/S, where the number of successes m is a random variable that follows the binomial distribution:

$$B ( m , S , {P}_{0} ) = ( \begin{matrix}S \\ m\end{matrix} ) {P}_{0}^{m} {( 1 - {P}_{0} )}^{S - m}$$

Hence Var[m]=SP₀(1-P₀)≤¼S, Var[P]=P₀(1-P₀)/S≤¼S, which implies:

$${σ}_{{y}_{q}} ∝ \sqrt{\frac{{2}^{d}}{S}} {C}_{d}$$

This means that s must grow at least as 2^{d} in order to hold y_{q} constant in d. Since also C_{d} increases with d, S should grow even faster. The error y_{q} is clearly hardware independent. The implementation on a quantum device, rather than a simulator, requests further analysis of the hardware-dependent errors.

Multi-qubit operations on a quantum device are subject to two kinds of errors: namely, the limited coherence times of the qubits and the physical implementations of the gates.

Therefore, the number of gates (the circuit depth) has a double influence on the error: a large number of gates requires a longer circuit run time which is limited by the coherence times of the qubits moreover each gate introduces an error due to its fidelity with respect to the ideal gate. The evaluation of the number of gates gives an estimate of the hardware-dependent error. The number of gates of the proposed qubit-based perceptron algorithm is ˜330 for d=1 and it increases by ˜400 when d increases by 1, in other words almost linearly with d. Instead, the number of gates depends exponentially on n.

Depending on the size of the problem and the maturity of the technology to implement the physical qubits, a real application should require to use logical qubits or at least to integrate quantum error correction coding embedded within the algorithm. These prerequisites are especially necessary if the quantum amplitude estimation algorithm is applied to estimate y_{q} as illustrated above. In such algorithm the depth of the circuit increases as O(M N d), but the error over the estimation of y_{q} decreases with M⁻¹. Indeed, since at most |ã-a|˜O(M⁻¹) where M=2^{m}, the error can be reduced exponentially by increasing m, the number of additional qubits of the quantum amplitude estimation algorithm.

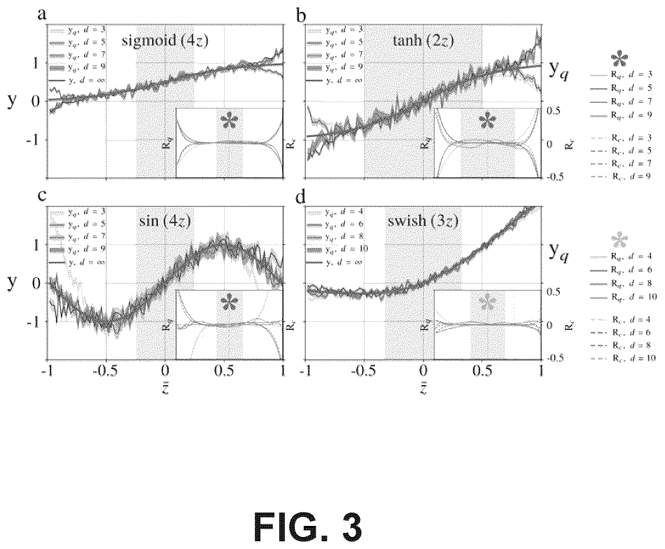

The FIG. 3 provides an enlarged view of the output of a quantum one-layer perceptron with different analytical activation functions. The output of the classical perceptron y (baselines) as a function of z is computed with four different target activation functions f: a hyperbolic tangent tanh(z) (FIG. 3, diagram a), a logistic function sigmoid(z) (FIG. 3, diagram b), a sine function sin(z) (FIG. 3, diagram c) and the swish function z·sigmoid(z) (FIG. 3, diagram d). It can be seen that the estimation of the quantum perceptron output y_{q} well approximates y at the polynomial expansion's order of d=3 computed with S=216 samples, d=5 with S=218, d=7 with S=220 and d=9 with S=222 in the cases (a), (b) and (c) while for the swish function the correspondent lines are of one extra order (d+1) and the same number of samples. In the lower right graphs the plots of R_{c} and R_{q} are shown in function of z and at different order d. The grey regions delimit the interval of z rescaled by the factor k which is the relevant region of interest to behave as monotone activation function.

In order to show a practical example, an implementation of a quantum one-layer perceptron with Nᵢₙ =4 is described here below.

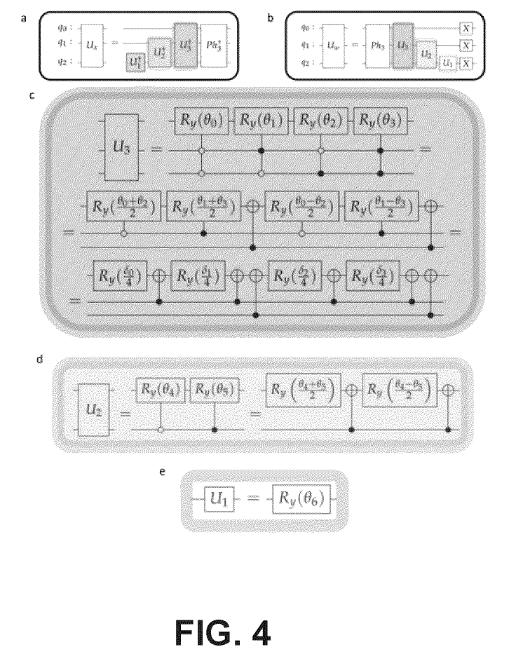

With Nᵢₙ =4, z is computed with n=3 qubits. To test the algorithm, the analytic activation functions f to be approximated are the hyperbolic tangent, the sigmoid, the sine and the swish function respectively (as shown in FIG. 4).

FIG. 4 illustrates fundamental gates composition of the transformations U_{W;b} and Uₓ. The transformations U(vₓ) and U(V_{xw;b}) encode respectively the coefficients of the vectors vₓ and V_{w;b}in a superposition quantum state. They are composed of the inverse of the operators Uᵢ where i=1; . . . ; n and Ph₃, which introduces the phases of the probability amplitudes. The operators U₃ (FIG. 4 box c), U₂ (FIG. 4 box d) and U₁ (FIG. 4 box e) are shown as composition of multi-controlled rotations Ry which are equal to a composition of gates R_{y} and Controlled-Not.

The transformation Ph₃⁺ (FIG. 4 box a) introduces the phases of the amplitudes while Ph₃ (FIG. 4 box b) removes them.

To estimate the perceptron output y_{q}, n+d+1 qubits are required where d is the order of approximation of the activation function ƒ. The output y_{q} is computed following the above illustrated equation:

$${y}_{q} = {2}^{d / 2} \sqrt{\overline{a}} {C}_{d} - γ$$

where the probability P is estimated with the measurement of s copies of the quantum circuit in the FIG. 2B, and where y is the shift value used to make the function ƒ_{d}(z)∈[0,1] within z∈[−1, 1].

To evaluate the effectiveness of the algorithm in reconstructing the chosen activation function ƒ, the output yq is compared with f(z) at different values of the inputs xᵢ, the weights wᵢ and the bias b, where i=0; 1; 2; 3.

The evaluation is extended on different activation functions also to different orders d, in order to exhaustively check the algorithm.

The weight vector is set to w=(1; 1; 1; 1) and the bias to b=0. The input vector x varies as x=z(1; 1; 1; 1) with z∈[1, 1]. In order to make the approximation capability manifest, since plotting as a function of z the activation functions does not differ significantly from their linear approximation, we consider a rescaled horizontal axis by f(kz) with k=4 for the sigmoid and the sine function, k=3 for the swish function and k=2 for the hyperbolic tangent. In FIG. 3 the different activation functions f are plotted versus z= 5/4 z∈[1, 1]. The rescaled factor here employed only to better show the effectiveness of the algorithm, can be set arbitrarily through the computation of the angles θ, according to Theorem 2, by simply considering the Taylor expansions of f(kz).

In this exemplary implementation option, the quantum perceptron algorithm has been developed in Python using the open-source quantum computing framework QisKit.

The quantum circuit was run on the local quantum simulator qasm simulator available in the QisKit framework.

Using a simulator, the only error over the estimated value y_{q} is Υ_{yq}. To keep σ_{yq} constant, the number of samples S must increase with d to compensate the factor 2^{d/2}C_{d}. FIG. 3 was obtained with the starting choice S=216 and d=3.

To evaluate how well y_{q} approximates the d-order Taylor expansion of a given activation function, let's define R_{q}=y-ŷq, where y=f(z) and ŷq is its polynomial fit.

The values R_{q} are compared with R_{c} =y-T_{d}, where T_{d} is the Taylor expansion of order d. For k=1, the full Taylor series of the activation functions under study converge in the interval [1, 1] of z. However, only in the case of the sine function the convergence holds true all over R. As a consequence, for f(z)=sin(4z), Rₑ goes to 0 for any value of z when d increases. For the other functions in FIG. 3 the convergence radius of the polynomial series is finite and it depends on k. In the case of tanh(2z), for instance, the convergence radius is less than 1 and Rc does not decrease with d for z large enough. Therefore, it is more representative to compare R_{q} with R_{c} rather than the activation function itself.

To quantify the difference between R_{q} and R_{c}, let's compute the mean square error (MSE) at different orders d in the grey region of z in the FIG. 3. The value of MSE between R_{q} and R_{c} is almost always of the order 10⁻⁵ for d=3 (4 for the swish) and 10⁻⁴ when d increases. For the hyperbolic tangent the MSE is of the order 10⁻³ when d=7 and 9.

The reason of such difference between tanh and the other functions is due to the trend of C_{d} with d. Indeed, C_{d} increases with d, therefore, it is not sufficient to duplicate S when d increases by 1 because C_{d} becomes relevant. Such an effect is more evident if the rescale factor k is high.

Indeed, for the examined functions, with k=1 the contribution of C_{d} to the error of y_{q} is not relevant also for a high value of d, because C_{d} increase polynomially with d if k=1. At higher values of k, C_{d} increases exponentially with d and it gives a relevant contribution to the error.

It should be noticed that the object of the present invention is fully achieved by the method described above by virtue of its functional features.

In fact, with reference to the above mentioned drawback that qubits are destroyed at the measurement event, the present method provides the solution of delaying the measurement action until the end of the computational flow, after having processed the information through neurons with a suitable activation function.

A fully reversible algorithm has been developed.

In this novel approach, we define a n-to-2¹ encoding model that involves inputs, weights, and bias. The model exploits the architecture of gate-model quantum computers to implement any analytical activation function at arbitrary approximation only using reversible operations.

As described above, the algorithm consists in iterating the computation of all the powers of the inner product up to d-th order, where d is a given overhead of qubits with respect to the n used for the encoding. Consequently, the approximation of most common activation functions can be computed by rebuilding its Taylor series truncated at the d-th order.

For example, the algorithm can be implemented in the QisKit environment to build a one layer perceptron with 4 input neurons and different activation functions generated by power expansion such as hyperbolic tangent, sigmoid, sine and swish function respectively, truncated up to the 10-th order.

Already at the third order, which corresponds to the least number of qubits required for a non-linear function, a satisfactory approximation of the activation function is achieved.

To conclude, the quantum perceptron algorithm of the present method fills the lack of a method to create arbitrary activation functions on a quantum computer, by approximating any analytic activation functions to any given order of its power series, with continuous values as input, weights and biases. Unlike previous proposals, this method shows how to approximate any analytic function at arbitrary approximation without the need to measure the states encoding the information.

By construction the algorithm bridges quantum neural networks implemented on quantum computers with the requirements to enable universal approximation as from Hornik's theorem.

These results pave the way towards mathematically grounded quantum machine learning based on quantum neural networks.

In order to meet contingent needs, those skilled in the art can make changes and adaptations to the embodiments of the method and system described above, and can replace elements with others which are functionally equivalent, without departing from the scope of the following claims. All the features described above as belonging to a possible embodiment may be implemented irrespective of the other embodiments described.

1. A computer implemented method for performing quantum calculations in a quantum neural network,
wherein said neural network comprises at least one input layer comprising a first number (Nᵢₙ) of input layer neurons adapted to receive respective input values (xᵢ) belonging to an input vector (x), each input layer neuron being configured to multiply the respective input value (xᵢ) by a respective weight value (wᵢ) belonging to a weight vector (w),
and wherein said neural network further comprises at least one calculation neuron, operatively connected to said input layer, and configured to provide a computation result (y=f(z)) calculated by applying an activation function (ƒ) to an argument (z), said argument (z) being a scalar number calculated by the calculation neuron as the sum of the products of the input values (xᵢ) by the respective weights (wᵢ) plus a bias value (b),
wherein the method comprises the steps of:
encoding, by a first quantum process, the input values (xᵢ) of the input vector (x) into probability amplitudes of a n-qubits initial first quantum state, stored in an input register (q), through a n-to-2ⁿ input encoding model, wherein the number of qubits (n) of the initial first quantum state is such that 2ⁿ is greater or equal to a second number equal to Nᵢₙ+3, where Nᵢₙ corresponds to the input vector dimension;
applying a quantum operator, depending on the weight values (wᵢ) of the weight vector (w) and the bias (b), to said input register (q) to calculate said argument (z) as the addition of the bias (b) and the inner product of the input vector (x) and the weight vector (w);
by the application of said quantum operator, producing as result a second quantum state, of the input register q, which has the value 1 and the value of the argument (z) encoded;
processing, by a second quantum process, said second quantum state of the input register (q), to calculate a value of each of a number of powers (d-1) of said argument (z), from the second order power (z²) up to the d-th order power (z^{d}), using an additional quantum buffer register (a);
by the application of said second quantum process, producing as result a third (n+d)-qubits quantum state, of the input register (q) and the additional quantum buffer register (a), which has said values (1, z, z², . . . ,z^{d}) encoded;
processing, by a third quantum process, said third quantum state to calculate said computation result (y) as a polynomial series expansion of the activation function (ƒ), through quantum states rotations, with the rotation angles depending on coefficients of said activation function polynomial series expansion;
encoding said calculated computation result (y) into a fourth quantum state, which is suitable either to be measured and detected or to be provided, as a not yet measured quantum state, to a further neuron of the neural network.

2. Method according to claim 1, wherein said step of applying a quantum operator to the input register (q) provides the following quantum operations:
2ⁿ-1 quantum states rotations, with the rotation angles depending on the weight values (wᵢ) of the weight vector (w) and the bias (b) such that 2ⁿ is greater or equal to said second number (Nᵢₙ+3);
processing said n-qubits initial first quantum state and the quantum operator depending on the weight and bias to calculate said argument (z) as the addition of the bias (b) and the inner product of the input vector (x) and the weight vector (w).

3. Method according to claim 1, wherein said number of powers (d) is less than 10 so that the activation function is approximated by a Taylor series expansion having 10 addends or less.

4. Method according to claim 3, wherein said number of powers (d) is 3 so that the activation function is approximated by a Taylor series expansion having 3 addends.

5. Method according to any claim 1, wherein said weights (wᵢ) and bias (b) are comprised in the closed range of real numbers comprised between −1 and 1.

6. Method according to claim 1, wherein said step of processing, by a second quantum process, the second quantum state to calculate a value of each of a number of powers (d-1) of the argument (z) comprises:
applying by the second quantum process a unitary transformation U_{z}(x, w, b) which satisfies the following equation:
$$〈 N - 1 \vert {U}_{𝓏} ( \vec{x} , \vec{w} , b ) \vert 0 〉 = \frac{\vec{w} \cdot \vec{x} + b}{{N}_{in} + 1} ≡ 𝓏$$
$$where \vert 0 〉 ≡ \vert 0 {〉}^{⊗ n} and \vert N - 1 〉 ≡ \vert 1 {〉}^{⊗ n} .$$

7. Method according to claim 1, wherein said step of producing a third (n+d)-qubits quantum state comprises:
transforming the input register (q) and the additional quantum buffer register (a) from an initial state |0>_{a |}0>_{q} to a (n+d)-qubit entangled state |ψ_{z}^{d}> according to the relationship:
$$\vert {ψ}_{𝓏}^{d} 〉 = \vert {ψ}_{𝓏}^{d} {〉}_{⊥} + \frac{1}{{2}^{d / 2}} \vert 𝓏 {〉}_{a}^{⊗ d} \vert N - 1 {〉}_{q}$$
$$where$$
$$\vert N - 1 〉 〈 N - 1 {\vert}_{q} \vert {ψ}_{𝓏}^{d} {〉}_{⊥} = 0$$
$$\vert 𝓏 〉 ≡ \vert 0 〉 + 𝓏 \vert 1 〉 .$$
wherein the state |ψ_{z}^{d} [symbol] stores as probability amplitudes all the powers z^{k}, for k=0, 1, . . . , d.

8. Method according to claim 7, wherein said step of processing, by a third quantum process, the third quantum state to calculate the computation result (y) comprises:
transforming the state |ψ_{z}^{d} [symbol] so as to achieve a special recursively defined d-degree polynomial in z, by means of a unitary operator (U_{d}) of the family (Uₖ; k=1, . . . , d) of unitary operators such that
$${}_{a} 〈 0 \vert {U}_{k} \vert 𝓏 {〉}_{a}^{⊗ d} = {f}_{k} ( 𝓏 )$$
where fₖ(z) is the polynomial series expansion of the activation function up to the k-th power, and f_{d}(z) is the polynomial series expansion of the activation function up to the d-th power,
and wherein Uₖ is obtained through a recursive law Uₖ=Cₖ Uₖ₋₁, wherein Cₖare operators depending on the specific activation function (ƒ) considered.

9. Method according to claim 8, wherein said step of processing by a third quantum process further comprises:
defining the rotation angles, based on said polynomial series expansion of the activation function up to the d-th power, to obtain an approximated activation function ƒ_{d}(z), approximating the activation function ƒ(z), said approximated activation function ƒ_{d}(z) being associated to the final quantum state |ψ_{f(z)}^{d} [symbol] .

10. A computer implemented method for implementing a quantum neural network,
wherein said quantum neural network comprises at least one input layer and one output layer, wherein the at least one input layer comprises a first number (Nᵢₙ) of input layer neurons adapted to receive respective input values (xᵢ) belonging to an input vector (x), each input layer neuron being configured to multiply the respective input value (xᵢ) by a respective weight value (wᵢ) belonging to a weight vector (w), and wherein the at least one output layer comprises an output layer neuron configured to provide a computation result (y=f(z)) calculated by applying an activation function (ƒ) to an argument (z), said argument (z) being a scalar number calculated by the output layer neuron as the sum of the products of the input values (xᵢ) and respective weights (wᵢ) plus a bias value (b),
the method comprising:
executing the method for performing quantum calculations in a quantum neural network, according to claim 1, wherein said calculation neuron plays the role of output layer neuron;
measuring the calculated computation result (y), encoded in said fourth quantum state, to detect and made available the result of the neural network computation.

11. A method according to claim 10, wherein the neural network output layer comprises one or more output layer neurons, and wherein said neural network is a multi-layer neural network further comprising at least one intermediate layer, wherein the intermediate layer comprises a plurality of intermediate-layer neurons, each of the intermediate-layer neurons being connected to all the input layer neurons, in input, and to said one or more output layer neurons, in output,
wherein the method further comprises:
for each of the intermediate-layer neurons, executing the method for performing quantum calculations in a quantum neural network, wherein said calculation neuron plays the role of intermediate-layer neuron, and the intermediate-layer neuron provides, as a computation result (y), a computation value (xᵢ);
providing all the calculated computation values (xᵢ), as a not yet measured quantum state, to the one or more output layer neurons, so that, from the point of view of the output layer neurons, the intermediate layer plays the role of the input layer of said method for performing quantum calculations in a quantum neural network;
measuring the calculated computation result (y), by the one or more output layer neurons, to detect and made available the result of the neural network computation.

12. A method according to claim 11, wherein said neural network is a multi-layer neural network further comprising a plurality of intermediate layers, wherein each neuron of an intermediate layer is connected, in input, to all the neurons of the preceding intermediate layer, and the one or more output layer neurons are connected to the outputs of the neurons of the last intermediate layer,
and wherein said step of executing, for each of the intermediate-layer neurons, the method for performing quantum calculations in a quantum neural network the intermediate layer is repeated for each intermediate layer.

13. Method according to claim 10, wherein the only quantum measurement provided by the method is carried out to detect the amplitudes of the quantum states after the processing by said output layer neurons, to obtain said computation result (y).

14. A quantum computation system for performing quantum calculations in a quantum neural network,
wherein said neural network comprises at least one input layer comprising a first number (Nᵢₙ) of input layer neurons adapted to receive respective input values (xᵢ) belonging to an input vector (x), each input layer neuron being configured to multiply the respective input value (xᵢ) by a respective weight value (wᵢ) belonging to a weight vector (w),
and wherein said neural network further comprises at least one calculation neuron, operatively connected to said input layer, and configured to provide a computation result (y=f(z)) calculated by applying an activation function (ƒ) to an argument (z), said argument (z) being a scalar number calculated by the calculation neuron as the sum of the products of the input values (xᵢ) by the respective weights (wᵢ) plus a bias value (b),
wherein the system comprises:
a first quantum circuit, configured to encode the input values (xᵢ) of the input vector (x) into probability amplitudes of a n-qubits initial first quantum state, through a n-to-2ⁿ input encoding model, wherein the number of qubits (n) of the initial first quantum state is such that 2ⁿ is greater or equal to a second number equal Nᵢₙ+3 where Nᵢₙ corresponds to the input vector dimension;
an input register (x), configured to store said probability amplitudes of a n-qubits initial first quantum state;
quantum processing means, configured to apply a quantum operator, depending on the weight values (wᵢ) of the weight vector (w) and the bias (b), to said input register (q) to calculate said argument (z) as the addition of the bias (b) and the inner product of the input vector (x) and the weight vector (w), producing as result a second quantum state, of the input register q, which has the value 1 and the value of the argument (z) encoded;
a quantum buffer register (a), distinct from said input register;
a second quantum circuit, configured to be applied to said input register (x) and said quantum buffer register (a), to process said second quantum state to calculate a value of each of a number of powers (d) of said argument (z), from the second order power (z²) up to the d-th order power (z^{d}), producing as result a third (n+d)-qubits quantum state, of the input register (q) and the additional quantum buffer register (a), which has said values (1, z, z², . . . ,z^{d}) encoded;
a third quantum register configured to store said third (n+d)-qubits quantum state;
a third quantum circuit, operatively connected to said third quantum register, and configured to process said third quantum state to calculate said computation result (y) as a polynomial series expansion of the activation function (ƒ), through quantum states rotations, with the rotation angles depending on coefficients of said activation function polynomial series expansion;
a fourth quantum register, configured to store a fourth quantum state encoding said calculated computation result (y).

15. A quantum computation system for implementing a quantum neural network, comprising:
a quantum computation system for performing quantum calculations in a quantum neural network, according to claim 14;
quantum measurement means, configured to measure the calculated computation result (y), encoded in said fourth quantum state, to detect and made available the result of the neural network computation.
